(19) United States
(12) Patent Application Publication
(10) Pub. No.: US 2015/0246799 A1
(43) Pub. Date: Sep. 3, 2015

(54) DEVICE FOR LIFTING OBJECTS

(71) Applicant: PEINEMANN EQUIPMENT B.V., Hoogvliet (NL)

(72) Inventor: Leendert Cornelis Mizelmoe, Rotterdam (NL)

(21) Appl. No.: 14/429,116

(22) PCT Filed: Sep. 2, 2013
(86) PCT No.: PCT/NL2013/050633

§ 371 Date: Mar. 18, 2015

(30) Foreign Application Priority Data
Sep. 18, 2012 (NL) 2009481

(51) Int. Cl. B66F 9/07; B66F 9/075; B66F 9/22; B66F 11/04

(52) U.S. Cl. CPC B66F 9/07; B66F 11/042; B66F 9/07577; B66F 9/22

(57) ABSTRACT

Device (1) for lifting objects, such as electric motors for industrial fans, comprising: a base provided with wheels (15, 16); a base frame (3) arranged on the base; a lifting frame (5) movable in vertical direction relative to the base frame (3), wherein the lifting frame (5) comprises a holder (6) configured to hold the object; a double-action hydraulic cylinder (82) configured to displace the lifting frame (5) relative to the base frame (3).

The present invention relates to a device for lifting objects, such as electric motors for industrial fans. The invention also relates to a scissor lift provided with such a device.

Use is made in the chemical industry of heat exchangers in the form of pipes which extend mutually adjacently in a horizontal plane and in which the medium for cooling flows. Arranged under such a bed of pipes are fans which carry relatively cold ambient air in a vertical direction along the pipes of the heat exchanger. Such fans are provided with electric motors which drive the blades of the fan. Such electric motors are susceptible to wear, requiring them to be overhauled from time to time.

For such an overhaul, but also in the event a motor fails due to a malfunction, the motor has to be removed. Arranged for this purpose through a typical industrial plant are walkways constructed from steel gratings. Using these walkways it is usually possible to reach a position close to, particularly under, such a motor. This is not always the case however, so that in these cases in particular the uncoupling and removal of the motor is complicated and not without risk.

Even when a motor for replacing is located above a walkway, the uncoupling, removal and subsequent taking away are not simple either. It is for instance known to connect a sling to the plant, for instance the frame or even a pipe of a heat exchanger, so as to enable lowering of the motor by this sling after it has been uncoupled. Connecting the sling and then lowering the motor is not without risk here to the mechanics. The plant itself can moreover be damaged.

It is therefore an object, among others, of the present invention to provide a safe, efficient and/or simple device for lifting objects, such as electric motors for industrial fans, with which the above stated problems are at least partially obviated.

This object and others are achieved with a device as defined in claim 1.

This object is achieved more particularly with a device for lifting objects, such as electric motors for industrial fans, comprising:
a base provided with wheels;
a base frame arranged on the base;
a lifting frame movable in vertical direction relative to the base frame, wherein the lifting frame comprises a holder configured to hold the object;
a double-action hydraulic cylinder configured to displace the lifting frame relative to the base frame.

The device provided with wheels can be efficiently moved close to the object, for instance a motor for processing, after which the lifting frame can be displaced to a raised position using the hydraulic cylinder such that the holder comes into contact with the object. The holder is preferably embodied here with a suitable receiving part for the object. The holder more preferably comprises a horizontally extending surface in which a slot is preferably arranged. This slot can receive the connection of a motor, which is normally situated on the underside of the motor.

In order to enable easy adjustment of the device to the object for processing it is moreover advantageous for the holder to be releasably connected to the lifting frame, for instance with nut and bolt connections. It is moreover advantageous for a number of connecting positions for a holder to be arranged on the lifting frame, wherein these connecting positions are situated at different locations in the vertical directions. This enables an adjustment of the device to the size, particularly the height, of the object for lifting.

Because use is made of a double-action hydraulic cylinder, the lowering of the lifting frame takes place actively during movement to the lowered position. Should a malfunction occur on a side of the hydraulic piston, the lifting frame will not then move downward under the influence of gravitational force.

The base frame and the lifting frame are preferably arranged in a width direction of the device. The holder is preferably connected here to the lifting frame such that it protrudes in a direction transversely of this width direction.

It is particularly advantageous that the lifting device according to the invention can be used and displaced on the walkways arranged in industrial plants. Depending on the application or supplier, such walkways typically have a maximum width of about 75 cm or about 87 cm. A preferred embodiment of the device according to the invention therefore has a maximum width equal to or smaller than about 75 cm. Another embodiment can have a maximum width of 87 cm or smaller.

In order to further increase the utility of the device, the device preferably has a turning circle equal to or smaller than respectively 75 cm or 87 cm. The device, and particularly the wheels thereof, are then configured such that the bend between two walkways of respectively 75 cm or 87 cm placed perpendicularly of each other can be negotiated.

According to a further preferred embodiment, one pair of fixed wheels having a shared rotation axis is arranged on the base. These fixed, i.e. non-swivelling, wheels impart stability to the device. It is possible here for the wheels to have a shared wheel shaft, although it is also possible for the wheels to have separate wheel shafts lying mutually in line. Furthermore, the rotation axis for this purpose preferably lies in line with the base frame for a good transfer of forces.

For the purpose of manoeuvrability it is moreover advantageous for at least one swivel wheel to be arranged at a distance from the rotation axis on the base. The holder, as seen in top view, then preferably extends between the fixed wheels and the swivel wheel such that the centre of gravity also lies between these wheels. The distance between this swivel wheel and the two fixed wheels is preferably the same so that a stable assembly is obtained.

For the sake of stability it is further favourable for this distance between the rotation axis and the swivel wheel to be as great as possible. In order to however also provide a good manoeuvrability, particularly in bends of walkways, it is advantageous for the swivel wheel to be arranged at a distance from the rotation axis such that the swivel wheel and the fixed wheels are enclosed by an equilateral triangle, the sides of which have a length roughly corresponding to the length of the wheelbase, in particular the maximum width of the device, and wherein the wheels lie close to the vertices of this triangle. The distance between the wheels is maximal here, while the device is nevertheless prevented from coming into contact with the upright walls of the walkways in bends.

For a further improvement in stability two swivel wheels are preferably arranged on either side of the rotation axis. One swivel wheel is then arranged on each side of the rotation axis, preferably in the above described manner.

The walkways usually constructed from metal gratings have a limited capacity in respect of load-bearing capacity. By way of indication, a load of 290 kg/m² is set as maximum at some factory sites. In order to still be able to utilize the device according to the invention in such walkways, it is advantageous for the device to be manufactured substantially from aluminium. At least the largest and, thereby the potentially heaviest components, such as the base, the base frame and the lifting frame, are preferably manufactured from aluminium.

According to a further preferred embodiment, the wheels are free-running wheels, i.e. non-driven wheels. Weight-saving can therefore be achieved when the device does not comprise a motor. According to this embodiment, the device has to be driven by manpower or at least by an external drive. It is particularly advantageous for the device to be simply pushed along the walkways. The device can be provided for this purpose with a suitable push bar.

According to a further preferred embodiment, the device comprises a hydraulic hand pump for operating the hydraulic cylinder. The weight of a motor, for instance an electric motor or a combustion engine, is saved here. Additionally or alternatively, it is also possible to provide a relatively long conduit between the cylinder and the pump. During use the pump, which can then optionally take a motorized form, can be used at a distance from the device. This distance then amounts to at least 1 metre, preferably at least 2 metres. The conduit then has for this purpose at least a corresponding length.

In order to enable efficient deployment of the device on walkways arranged at a height above the ground, it is advantageous for the device to be provided with at least one lifting eye. At least two lifting eyes are preferably provided for stable hoisting of the device.

A further preferred embodiment of the device is configured to be arranged and displaced on at least one rail which is configured for connection to a scissor lift. This makes it possible to arrange the device on a scissor lift so that motors which are not accessible via a walkway can also be disconnected and removed in simple manner. A rail, preferably two rails, over which the device can move are connected for this purpose to the platform, or deck, of a scissor lift. The rails are preferably arranged in a direction transversely of the direction of forward movement of the scissor lift. The scissor lift can be used to align in a first direction, while the device can be aligned over the rail in a second direction perpendicular to this first direction. In this way the scissor lift need not be maneuvered backwards and forwards in order to carry the device under the motor for processing.

It is advantageous here to arrange on the base first wheels which are configured to roll on top of the rails and wherein at least one second wheel configured to roll on the underside of the rails is also arranged removably on the base, wherein in connected situation the rails are situated between the first and second wheels. In order to arrange the device on the rails the second wheel, which is for instance mountable using a nut and bolt connection, is removed so that the first wheels rest on the rail. The second wheel is then arranged, wherein the rail is received between the two wheels. The device is in this way arranged firmly on the rails and the possibility of it coming off the rails, for instance when the scissor lift is moved upward or downward, is prevented. A plurality of sets of first and second wheels, preferably four, are preferably provided.

A further preferred embodiment comprises a drive member movable in vertical direction relative to the base frame and the lifting frame, wherein the hydraulic cylinder is arranged between the base frame and the drive member for the purpose of moving the drive member relative to the base frame. A transmission can then be arranged between the base frame and the lifting frame, wherein the transmission runs via a guide arranged on the drive member for the purpose of lifting the lifting frame relative to the base frame by moving the drive member. The movement of the drive member relative to the base frame under the influence of the cylinder will thus also move the lifting frame relative to the drive member. In the raised position of the device the drive member preferably extends between the base frame and the lifting frame, in particular between the underside of the base frame and the upper side of the lifting frame. It is advantageous here that with a relatively small stroke of the cylinder, which corresponds to the displacement of the drive member relative to the base frame, it is possible via the transmission to make a greater stroke between the base frame and the lifting frame. In the lowered position of the device the lifting frame and the drive member are preferably situated in or at least at the same height as the base frame.

Although use can for instance be made of a chain as transmission and a toothed wheel as guide, a lifting cable is preferably arranged as transmission between the base frame and the lifting frame, wherein the lifting cable runs via a pulley arranged on the drive member for the purpose of lifting the lifting frame relative to the base frame by moving the drive member. This saves weight, while an efficient lifting can moreover be provided. The lifting cable extends here from and is connected to the base frame and runs via a pulley of the drive member and then ends on, wherein it is connected to, the lifting frame.

In order to increase the stroke of the lifting frame between the raised position and the lowered position, the lifting cable is preferably connected close to the undersides of the base frame and the lifting frame, and wherein the pulley is situated close to the upper side of the drive member. In the lowered position the connections are preferably at at least the same height, while in the raised position the connection to the lifting frame lies roughly at the same height as the pulley of the drive member.

The lifting cable is particularly configured to lift the device. Exerting tension on this cable by moving the drive member will move the lifting frame upward relative to the base frame. The lowering of the lifting frame can take place by simply lowering a drive member, so that through the loss of the tension in the lifting cable the lifting frame descends again under its own weight.

In order however to provide an efficient movement to the lowered position which does not depend on the weight of the lifting frame, a lowering cable is preferably also arranged between the base frame and the lifting frame, wherein the lowering cable runs via a pulley arranged on the drive member for lowering the lifting frame relative to the base frame by moving the drive member, wherein the lowering cable is preferably connected close to the upper sides of the base frame and the lifting frame and wherein the pulley is situated close to the underside of the drive member. This cable will come under tension when the drive member moves downward and will thus pull the lifting frame downward.

It is therefore advantageous for the drive member to be provided with two pulleys: one for the lowering cable and one for the lifting cable, lying on either side or at least close to the outer ends of the drive member. It is advantageous here for the base frame, the drive member and the lifting frame to have roughly the same height. This results in a compact assembly in the lowered position, particularly in height direction, while the placing of the pulleys enables a large stroke to be made between the base frame and the lifting frame.

Two lifting cables which run parallel are preferably provided for safety purposes. It is moreover advantageous to provide two lowering cables which run parallel. Each of the cables runs here via a separate pulley. When use is thus made of the two lifting cables and two lowering cables, the drive member is provided with four pulleys. For a uniform loading of the frames the cables preferably extend adjacently of and at a distance from each other in the width direction of the frames.

At least the lifting cable preferably runs via a balancing device configured to correct a difference in tension between the two cables. In the event play were to occur in one of the cables, the balancing device can then compensate this difference so that the lifting or, in the case of a balancing device for the lowering cables, the lowering of the lifting frame proceeds in efficient manner.

The balancing device is more preferably connected pivotally to one of the frames or the drive member, wherein the two cables run on either side of this pivoting connection. When there is a difference in tension in the cables, the balancing device will pivot so that the tension on the two cables on either side of the hinge is equalized. It is possible for the balancing device to be provided with pulleys over which the cables run. A simpler construction is achieved if the cables are connected to the balancing device. The balancing device is more preferably connected close to the underside of the base frame, wherein the outer ends of the cables are connected to the balancing device.

Use is preferably made of steel cable for the lifting cable(s) and/or the lowering cable(s). These cables are strong, while still providing sufficient flexibility.

According to a further preferred embodiment, the base frame and the lifting frame each comprise two uprights connected by at least one cross beam. Such a construction provides good strength and stability. At least the uprights of one of the frames preferably have a U-shaped cross-section so that the uprights of the other frame can be received therein. In the lowered position the one frame, preferably the lifting frame, then lies within the uprights of the other frame, in particular the base frame.

Particularly when use is made of a drive member to increase the stroke of the lifting frame relative to the base frame, it is advantageous for the device to also comprise extension uprights, wherein the uprights of the frames and the extension uprights are arranged telescopically for the purpose of forming a telescopic frame. The extension uprights as it were extend the uprights of the base frame and the lifting frame so that they can move further apart. This makes it possible for the underside of the lifting frame to extend in the raised position above the upper side of the base frame, wherein the extension uprights connect the frames. The extension uprights preferably also take a U-shaped form and can be received in the U-shaped uprights of the base frame, wherein the lifting frame is then received in the U-shaped extension uprights. A very compact assembly is obtained when the cylinder, and optionally the drive member, are situated between the uprights of the telescopic frame.

The invention further relates to a scissor lift, the platform of which is provided with at least one rail and a device according to the invention, wherein the rail is preferably arranged in the direction transversely of the direction of forward movement of the scissor lift, wherein the device is movable in this direction transversely of the direction of forward movement of the scissor lift. The rail is preferably provided with connecting means for connecting the rail to the platform of the scissor lift. The connecting means can for instance comprise a clamp which engages on and/or round the platform. Two rails extending adjacently of each other are more preferably provided, wherein the device is provided with corresponding wheels so that it can travel on these rails placed at a mutual distance.

The present invention will be further illustrated with reference to the following figures, which show preferred embodiments of the device according to the invention and are not intended to limit the scope of the invention in any way, and in which:

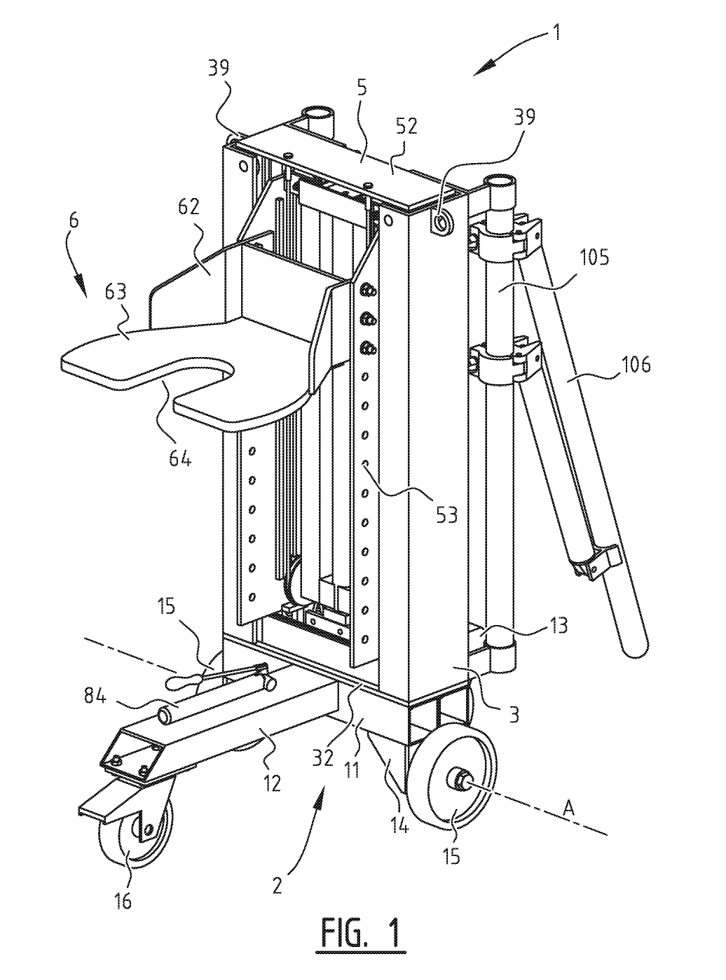

FIG. 1 is a perspective view of the device according to a first embodiment in lowered position;

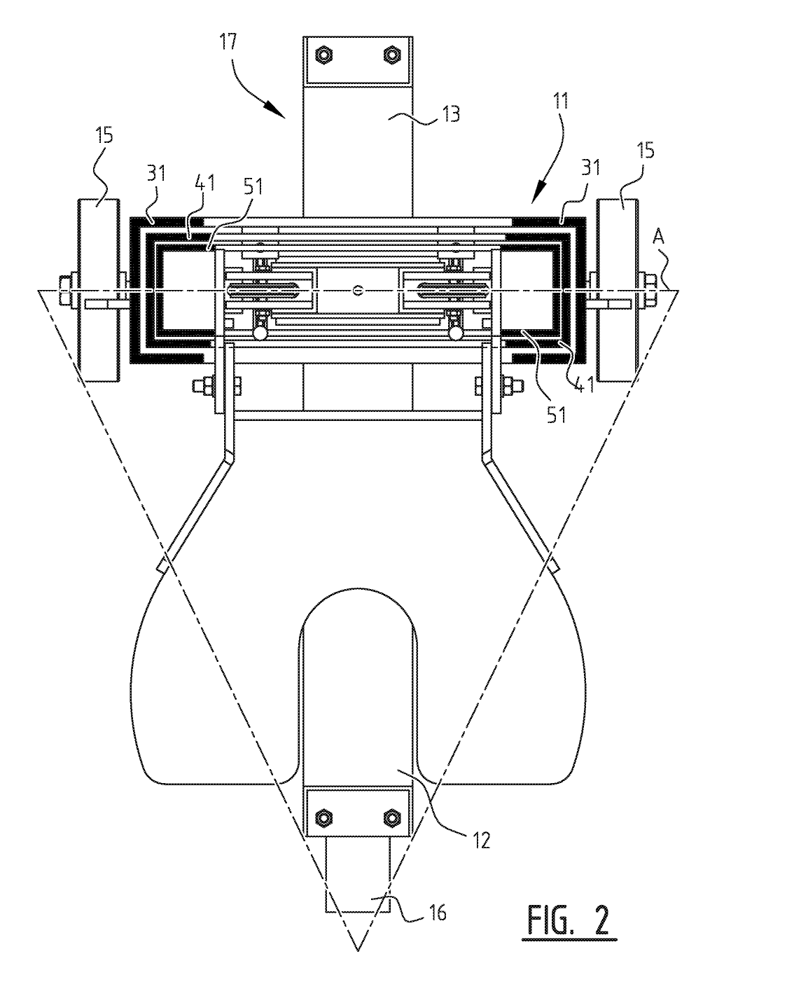

FIG. 2 is a top view of the device of FIG. 1;

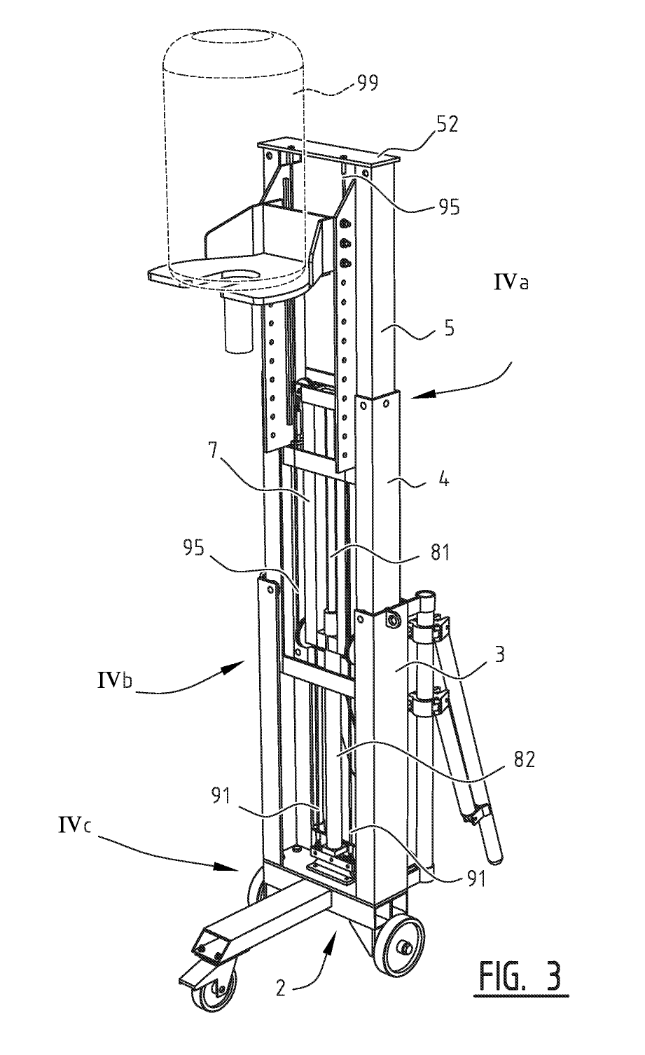

FIG. 3 shows the device of FIG. 1 in raised position;

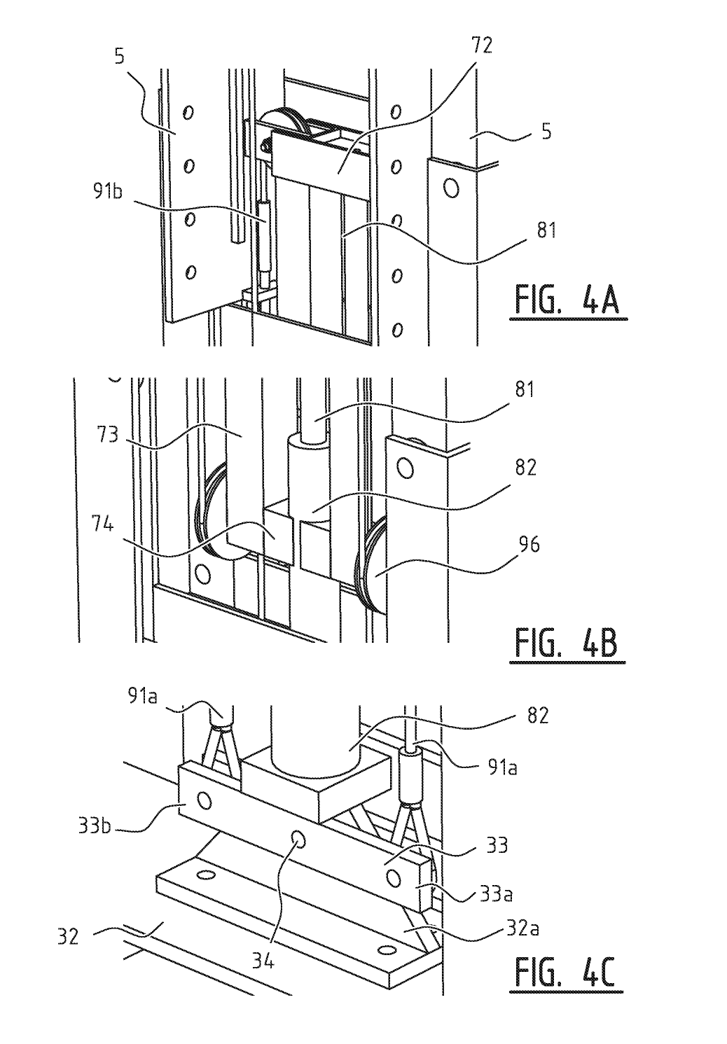

FIGS. 4a-c show details of FIG. 3;

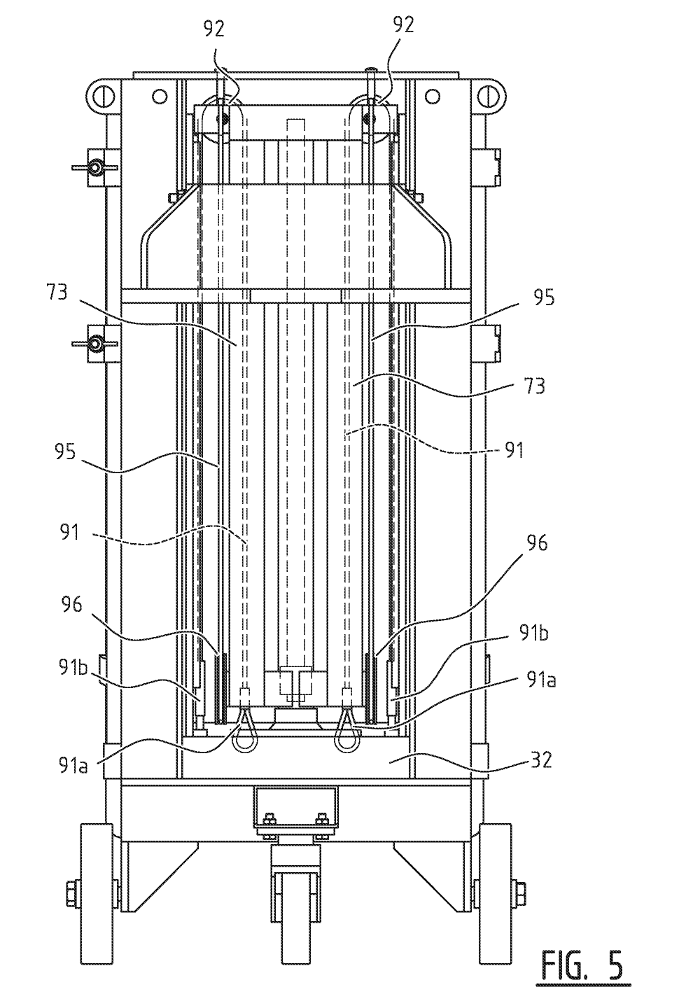

FIG. 5 is a front view of the device of FIG. 1;

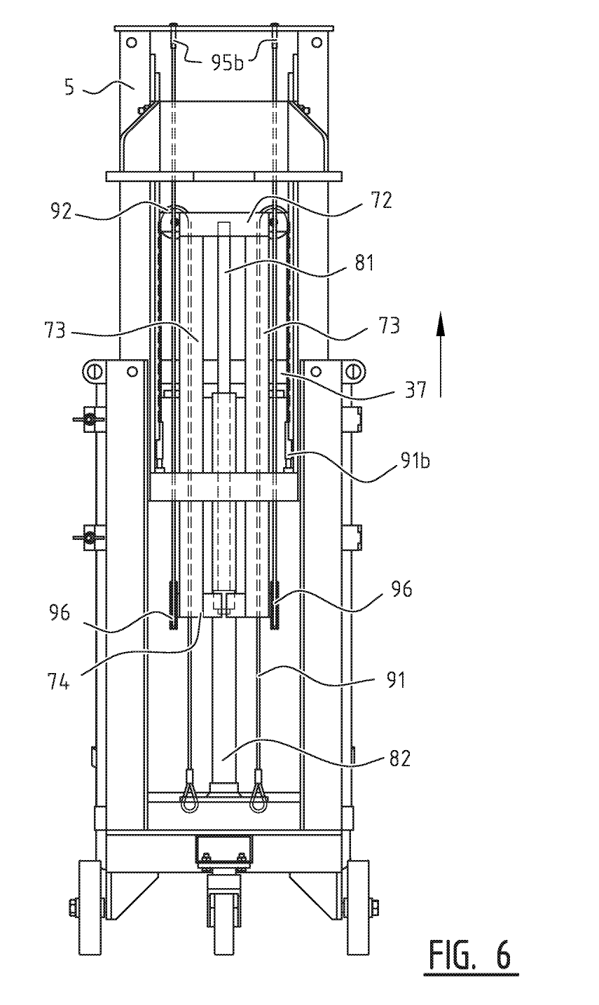

FIG. 6 shows a front view of the device while the lifting frame is being lifted;

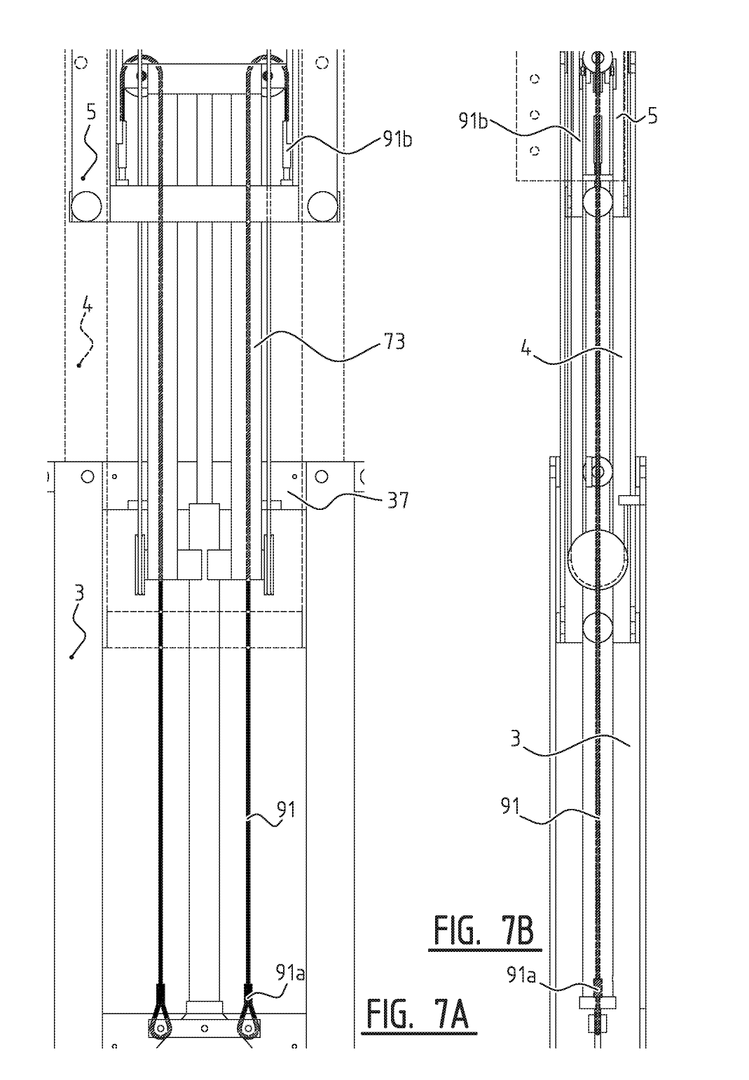

FIGS. 7a-d show the path of the cables;

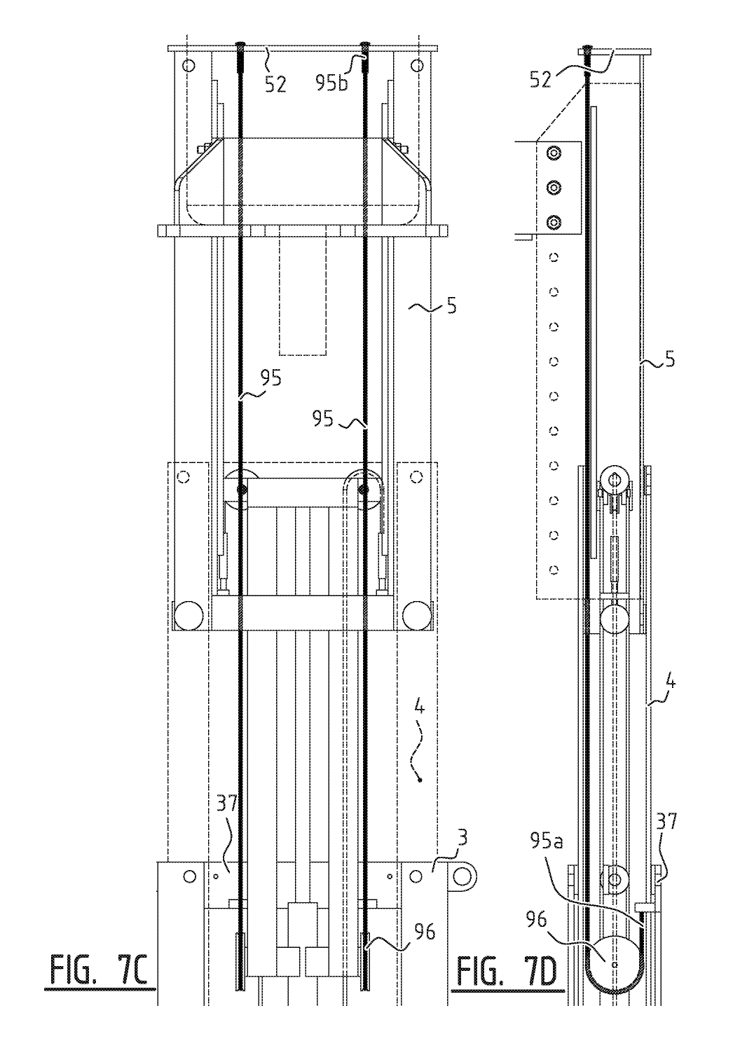

FIG. 8 is a perspective view of a second embodiment of the device according to the invention; and

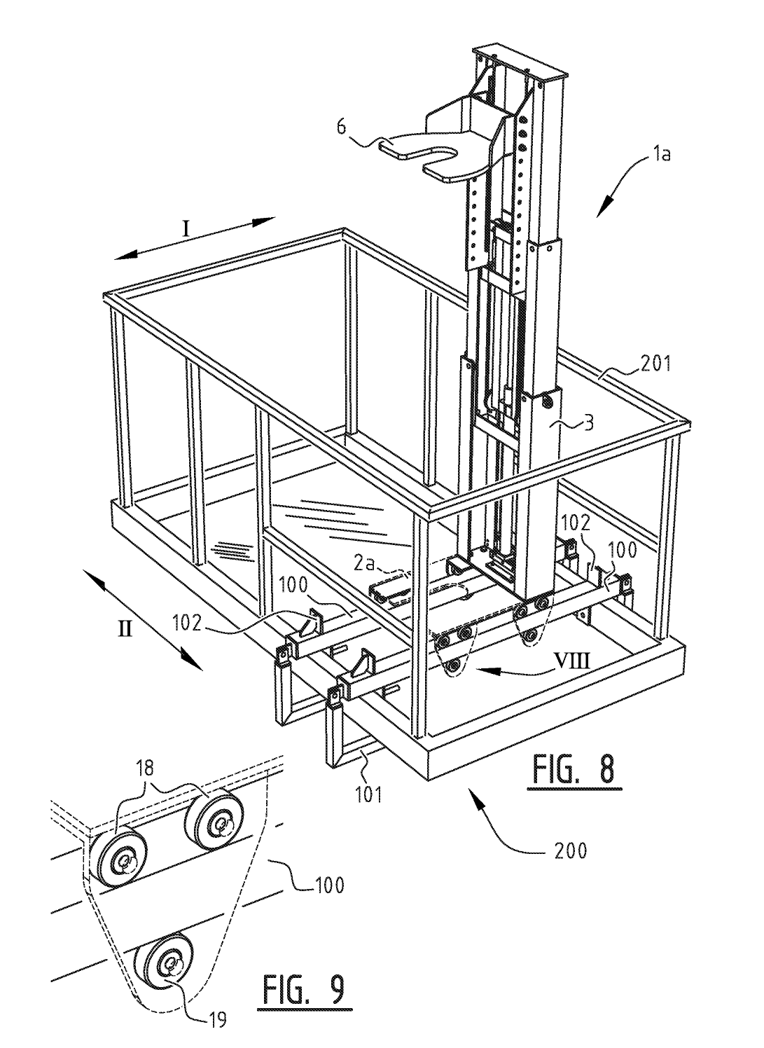

FIG. 9 shows a detail of FIG. 8.

FIG. 1 shows a device according to the invention in the form of a motor lifter 1. Lifter 1 is provided with abase 1 formed from two cross beams 11 on which wheels 15 are arranged via adapting parts 14. Wheels 15 have a shared rotation axis A, see FIG. 2. A swivel wheel 16 is moreover arranged via a beam 12 running in longitudinal direction. A second swivel wheel 17 (not shown) is moreover arranged via a beam 13 on the other side of rotation axis A.

The maximum width of motor lifter 1 is 75 cm, and swivel wheel 16 and wheels 15 form a triangle in top view. The maximum distance between swivel wheel 16 and wheels 15 is determined by the minimum width of the walkways in which the device is deployed. In order to be able to properly negotiate a bend in two mutually perpendicular walkways, the device according to this embodiment is enclosed by an equilateral triangle, the sides of which have a length smaller than or equal to this minimum width of this walkway.

A base frame 3 is arranged in the width direction on beams 11. Base frame 3 is provided with two U-shaped uprights 31, see FIG. 2, and is provided on the underside with a cross beam 32. A second cross beam 37 is furthermore provided on the upper side, see for instance FIGS. 6, 7a, 7c and 7d. Situated inside this frame 3 in the lowered position as shown in FIG. 1 is a lifting frame 5 also having U-shaped uprights 51 connected on the upper side to a cross beam 52. The heights of frames 3 and 5 roughly correspond so that in the lowered position frame 5 fits neatly in base frame 3.

Uprights 41 are arranged between uprights 31 of base frame 3 and uprights 51 of the lifting frame. These uprights also have a U-shaped cross-section. As shown clearly in FIG. 2, uprights 51 of lifting frame 5 are received in the U-shape of uprights 41, which are in turn also received in the U-shaped uprights 31 of base frame 3. A telescopic frame is thus obtained, this being clearly visible in FIG. 3 which shows motor lifter 1 in the raised position. Suitable stops and guides are arranged between uprights 31, 41 and 51.

Arranged on lifting frame 5 is a holder 6 configured to hold a motor 99, see FIG. 3. A plurality of holes 51 are arranged in two plates 53 of the lifting frame extending in the vertical direction. These holes 51 can be used to connect holder 6 via a rear wall 62 to the lifting frame using a nut and a bolt 61. The plurality of holes 51 moreover enables a height adjustment of holder 6 relative to lifting frame 5. Holder 6 is provided with plate 63 in which is arranged a slot 64 which has a shape complementary to that of motor 99. As shown clearly in FIG. 2, holder 6 is situated between wheels 15 and swivel wheel 16 for a stable assembly.

Tubes 105 on which supports 106 can be arranged are further arranged on base frame 3. If there is sufficient space during utilization of device 1, the supports 106 can be folded out for extra support. Also arranged on base frame 3 are lifting eyes 39 which can be used to enable hoisting of the motor lifter, for instance to an elevated walkway.

Lifting frame 5 is moved relative to base frame 3 using a double-action hydraulic cylinder 82 and piston 81 which can be operated with a hand pump 84 which is arranged in this embodiment on base 2. Cylinder 82 is arranged on the underside 32 of base frame 3, see FIG. 4c, and the outer end of piston 81 is arranged on a drive member in the form of driving frame 7. Referring to FIGS. 4a, 4b and particularly FIG. 6, piston 81 is connected to a cross beam 72 of driving frame 7. Pulleys 92, which will be discussed in more detail below, are further arranged on either side of this cross beam 72. Two U-shaped uprights 73 are arranged on cross beam 72. A second cross beam 74 is arranged on the outer end thereof. Pulleys 96 are arranged on either side thereof. The height of frame 7 corresponds to the height of frames 3 and 5, see FIG. 5. The lower cross beam 74 is arranged round cylinder 82, see FIG. 4b, so that frame 7 is guided efficiently. Driving frame 7 is movable here between base frame 3 and lifting frame 5 using cylinder 82. As can be clearly seen in FIG. 6, driving frame 7 is located between the uprights of frames 3 and 5.

In order to move lifting frame 5 relative to base frame 3 use is made of cables 91 and 95. Cables 91 are used to lift, cables 95 to lower lifting frame 5 relative to base frame 3.

Referring to FIGS. 4c, 7a and 7b, the outer ends 91a of lifting cables 91 are connected via a balance 33 to the underside 32 of the base frame. Balance 33 is connected via a foot 32a and a hinge 34. Cables 91 are connected close to the outer ends 33a and 33b of balance 33 by means of loops. Balance 33 eliminates possible differences in tension between the two cables 91. Lifting cables 91 then run through the U-shaped uprights 73 via the pulleys 92 which are arranged on the upper side of driving frame 7. The other outer ends 91b of the lifting cables are arranged on the underside of lifting frame 5, see FIGS. 5, 6 and 7a. In the lowered position the distance between pulleys 92 and outer ends 91b on lifting frame 5 is great, while in the raised position this distance is very small, see FIG. 7a. Using cables 91 it is possible with a limited stroke of piston 81 to nevertheless make a relatively large stroke with the lifting frame 5 driven via cables 91.

The cables 95, which are used to lower lifting frame 5 again, run in corresponding but opposite manner. The path of these lowering cables 95 is clearly visible in FIGS. 7c and 7d. The first outer ends 95a are fixedly connected to cross beam 37 on the upper side of base frame 3. Cables 95 then run via the pulleys 96 arranged on the underside of driving frame 7. The other outer ends 95b of cables 95 are fixedly connected to cross beam 52 on the upper side of lifting frame 5.

As shown clearly in FIG. 6, the assembly for lifting has a symmetrical construction, wherein cylinder 82 is arranged in the centre. The cables 91 and 95 arranged on either side of cylinder 82 then provide for a balanced driving.

The components of base 2, frames 3, 5, holder 6 and uprights 41 and driving frame 7 are manufactured from aluminium so that a light assembly is obtained. The use of steel cables for lifting the lifting device also results in a relatively light construction compared to for instance the use of chains with toothed wheels. The overall weight of the device is about 100 kg.

An alternative version of motor lifter 1a is shown in FIGS. 8 and 9. This embodiment is configured to be arranged on a platform 200 of a scissor lift. Such a platform 200 is typically provided with a fence enclosure 201 inside which personnel can stand. Two rails 100 are arranged round the bottom of platform 200 using clamps 101. Clamps 101 can pivot in order to enable the placing of rails. Stops 102 are provided on the outer ends of rails 100. Base 2a of this embodiment is provided with four sets of wheels. A set is shown in more detail in FIG. 9. Two wheels 18 are configured here to travel on rails 100, while a third wheel 19, which as seen in the longitudinal direction is located between wheels 18, is configured to roll along the undersides of rails 100. Using wheels 18, 19 the lifter 1a can move in a direction I relative to platform 200. The scissor lift with platform 200 can itself move back in the direction II in simple manner so that alignment of holder 6 is easy relative to a motor for processing.

The present invention is not limited to the shown embodiments but also extends to other embodiments falling within the scope of the appended claims. It will thus be apparent that the device is equally suitable for lifting and lowering objects other than motors.

1. Device for lifting objects, such as electric motors for industrial fans, comprising:
a base provided with wheels;
a base frame arranged on the base;
a lifting frame movable in vertical direction relative to the base frame, wherein the lifting frame comprises a holder configured to hold the object;
a double-action hydraulic cylinder configured to displace the lifting frame relative to the base frame.

2. Device as claimed in claim 1, wherein the device has a turning circle and a maximum width equal to or smaller than 75 cm.

3. Device as claimed in claim 1 or 2, wherein one pair of fixed wheels having a shared rotation axis is arranged on the base, wherein at least one swivel wheel is also arranged at a distance from the rotation axis such that the swivel wheel and the fixed wheels are enclosed by an equilateral triangle, the sides of which have a length corresponding to the length of the wheelbase, and wherein the wheels lie in the vertices of this triangle.

4. Device as claimed in claim 3, wherein two swivel wheels are arranged on either side of the rotation axis.

5. Device as claimed in claim 1, wherein the device is configured to be arranged and displaced on at least one rail which is configured for connection to a scissor lift, wherein first wheels are arranged on the base which are configured to roll on top of the rails and wherein at least one second wheel configured to roll on the underside of the rails is also arranged removably on the base, wherein in connected situation the rails are situated between the first and second wheels.

6. Device as claimed in at least one of the foregoing claims, wherein the device is manufactured substantially from aluminium.

7. Device as claimed in at least one of the foregoing claims, wherein the device does not comprise a motor.

8. Device as claimed in at least one of the foregoing claims, wherein the device comprises a hydraulic hand pump for operating the hydraulic cylinder.

9. Device as claimed in at least one of the foregoing claims, wherein the device is provided with at least one lifting eye for lifting the device.

10. Device as claimed in at least one of the foregoing claims, further comprising a drive member movable in vertical direction relative to the base frame and the lifting frame, wherein the hydraulic cylinder is arranged between the base frame and the drive member for the purpose of moving the drive member relative to the base frame, and wherein a lifting cable is arranged between the base frame and the lifting frame, wherein the lifting cable runs via a pulley arranged on the drive member for the purpose of lifting the lifting frame relative to the base frame by moving the drive member.

11. Device as claimed in claim 10, wherein the lifting cable is connected close to the undersides of the base frame and the lifting frame, and wherein the pulley is situated close to the upper side of the drive member.

12. Device as claimed in claim 10 or 11, wherein a lowering cable is also arranged between the base frame and the lifting frame, wherein the lowering cable runs via a pulley arranged on the drive member for lowering the lifting frame relative to the base frame by moving the drive member, wherein the lowering cable is connected close to the upper sides of the base frame and the lifting frame and wherein the pulley is situated close to the underside of the drive member.

13. Device as claimed in at least one of the claims 10-12, wherein two parallel lifting cables and lowering cables are provided, wherein each of the cables runs via a separate pulley and wherein at least the lifting cable runs via a balancing device configured to correct a difference in tension between the two cables, wherein the balancing device is connected pivotally to one of the frames or the drive member and wherein the two cables run on either side of this pivoting connection.

14. Device as claimed in at least one of the foregoing claims 10-13, wherein the base frame and the lifting frame each comprise two uprights connected by at least one cross beam, wherein the device also comprises extension uprights, wherein the uprights of the frames and the extension uprights are arranged telescopically for the purpose of forming a telescopic frame, wherein the cylinder and the drive member are situated between the uprights of the telescopic frame.

15. Scissor lift, the platform of which is provided with at least one rail and a device as claimed in at least claim 5, wherein the rail is arranged in the direction transversely of the direction of forward movement of the scissor lift, wherein the device is movable in this direction transversely of the direction of forward movement of the scissor lift.
